(19) United States
(12) Patent Application Publication
(10) Pub. No.: US 2011/0256278 A1
(43) Pub. Date: Oct. 20, 2011

(54) WHOLE OAT MICROWAVABLE BAKED ITEMS

(75) Inventors: Jim Hansa, Algonquin, IL (US); Andrew Sleyko, Chicago, IL (US)

(73) Assignee: The Quaker Oats Company, Chicago, IL (US)

(21) Appl. No.: 13/130,207

(22) PCT Filed: Nov. 20, 2009
(86) PCT No.: PCT/US09/65342

§ 371 Date: May 19, 2011

Related U.S. Application Data
(60) Provisional application No. 61/116,752, filed on Nov. 21, 2008.

(51) Int. Cl. A21D 10/04; A21D 13/08; A21D 13/02; A21D 2/08; A21D 8/06

(52) U.S. Cl. 426/243; 426/552; 426/559; 426/560; 426/94; 426/549; 426/496; 426/482

(57) ABSTRACT

A microwavable whole grain baked product prepared from a batter comprising whole grains, at least one leavening agent, at least one texturizing agent, and water.

### FIELD OF THE INVENTION

This invention relates to microwavable baked items prepared with whole grains, and in particular whole oats.

### BACKGROUND OF THE INVENTION

There exists a need for healthy and nutritious conveniently baked items.

### BRIEF SUMMARY OF THE INVENTION

A first embodiment of the invention is directed to a combination of microwavable whole grains and a bakery system comprising leavening and texturizing ingredients. The whole grains, leavening, and texturizing ingredients are combined with water and stirred into a batter to create a convenient microwavable warm whole grain baked analog. In particular, the whole grain is oats, wheat, corn, barley, and mixtures thereof.

The microwaved product has a soft tender texture like a muffin or a variety of textures, i.e. cookies, cakes, and breads. A benefit is that less sugar and fats are needed for a good tasting product.

### DETAILED DESCRIPTION OF THE INVENTION

Aspects of the invention are directed to a process and formulation to create microwave baked products containing whole grains and in particular whole oats. The products produced in accordance with the present invention provide the nutrition of a bowl of instant oatmeal through the high whole oat content of the batter and additional vitamins and minerals.

In one aspect, a microwavable whole grain batter comprises whole grains, at least one leavening agent, at least one texturizing agent, and water.

The whole grains may be whole oats, whole wheat, corn, barley, and mixtures thereof. The whole grains comprise at least 10wt %, at least 20wt %, or at least 30wt % of the total batter weight, for instance, 30wt % to 50wt %, or 40wt % to 50wt % based on total weight of the batter. The type(s) of milled grains will affect the texture. Milled grains may be fine pieces of flakes to whole flakes. The flakes are added in suitable amounts to provide appropriate cake density and whole grain piece identity. Two or more types of milled grains may be combined such as quick oats and baby oat flakes such as, for example, a combination of 50/50 ratio using a quick oat and baby oat flakes. The quick oat flake has a flake thickness of about 0.016 inches to about 0.020 inches, typically about 0.018 inches, flaked from a cut groat ⅓-⅙ its original size, and a baby instant oat with a flake thickness of about 0.013 inches to 0.020 inches, typically about 0.0175 inches, and piece size of the oat flake 1/9- 1/36 the original size of the native oats kernel.

Suitable leavening agents include, but are not limited to, baking powder, baking soda, monocalcium phosphate, potassium bitatrate (cream of tarter) and the like. Suitable amounts of acids are about 0.1% to about 0.4 wt % based on total weight of the batter.

An acid, such as citric acid, may be included to initiate a reaction with the leavening agents (e.g. sodium bicarbonate) prior to microwaving to increase leavening thus lightening cake density. Suitable amounts of acids are about 0.1% to about 0.4 wt %, typically about 0.2 wt %, based on total weight of the batter.

Suitable texturizing agents include starches, modified starches (e.g gelatinized starches), gum acacias, alginates, carrageenans, carboxymethylcellulose, gelatin, guar gum, locust bean gum, pectin, and xanthan gum. Suitable instant starches include, but are not limited to, corn starch and rice starch. The texturizing agents systems are used in amounts to produce the proper level of cake moistness and density through proper water adsorption. Suitable amounts of texturizing agents are about 0.1% to about 0.4 wt % based on total weight of the batter.

In addition to the above, the batter may include flour, sugar, proteins, and various other ingredients typically found in baked products such as nuts and chips.

Suitable flours include, but are not limited to, cake flour, wheat flour, corn flour, and oat flour. Suitable sugars include, but are not limited to, white sugar and brown sugar. Suitable proteins include, but are not limited to, eggs, egg whites, sodium caseinate, whey, wheat gluten, and the like.

Fruit pieces or nuts or chips such as chocolate chips or butterscotch chips, for example, may be included.

Flavors, colors, and other minor components also may be added. For example, flavors may be added to enhance or complement fruits or nuts already present, or simply as the sole flavor component. Not only may fruit and nut flavors be added, but also herbs and spices such as cinnamon, cloves, nutmeg, and the like may be used. Maple and other flavors also can be added. Suitable flavors are known to skilled practitioners.

A batter is prepared by combining, for example, whole grains, leavening agents, texturizing agents, flour, sugar, emulsifiers, and proteins, to form a dry mixture. Water and other moist ingredients are added to the dry mixture to form a batter.

The whole grains may be prepared by first removing the hulls from the whole grains. The grains are thermally processed to deactivate enzymes and provide desired hydrating and flavor properties. For example, the grains may be cut into 3-5 pieces and then cooked. The cooked grains are flaked. The flaked grains including all of the broken and small pieces are used in the product

Generally the amount of fruit and fiber can be higher than an average baked item containing no whole grains and the amount of sugar and fat can be lower than an average baked item containing no whole grains. This provides a much healthier alternative to off the shelf muffin mixes.

Microwave energy is then used to produce fresh nutritious bakery item. Typically the item is baked for 1 to 2 minutes, more typically, 1 to 1.5 minutes in a 1000 watt oven.

The present invention allows for the consumption of considerable amounts of whole grains, for example 20 to 30 g per 56 g serving in a fresh baked form for consumers who desire the health benefits of whole grains, but do not like the texture or taste of oatmeal porridge, for example.

The baked product may include a crusted topping. The topping is applied pre-microwaving. Suitable toppings include oat flakes, granola, breadcrumbs, and crisps. These may be combined with sugar, butter or shortening, and a spice or flavor. A suitable non-limiting example would be 3.5 wt % oat flakes, 3.8 wt % brown sugar, 0.9 wt % cinnamon, and 2.5 wt % shortening based on the total weigh of the baked product. The topping may be a dry crunchy top.

The process of making the microwaved baked product creates a fresh baked muffin with much lower fat and sugar and higher fiber and protein than traditional muffins. The product offers shelf-life advantages over traditional muffins, since it can be maintained for longer periods of time without the use of preservatives. The product offers a conveniently short preparation time over a traditionally baked muffin. For example, 1 to 2 minutes.

The bakery system allows uniform distribution of water throughout the baked item as well as a properly expanded texture. The grains are processed to allow for visual piece identity in the finished product without the creation of pastiness or chewiness.

Importantly, shaped items may be prepared in the microwave as the formulations will expand to the size of the cooking vessel and hold its form after completion. One example would be a muffin shaped container. Moreover, the viscous nature and property due to trapped steam of the cooked whole grain coupled with the gas generating leavening system combine to give a significant volume increase creating a light cell structure when microwaved.

The items can be eaten in the cooking vessel or can easily be removed for in-hand consumption. The product made in accordance with the present invention may be muffins, cookies, mini-loaves, cakes, coffee cakes, quick breads, corn bread, cookies, sweet rolls, and cobblers. The levels of the ingredients are adjusted to create desired textures.

A fruit filling can be created from a dry mix through the combination of freeze-dried or air dried fruit (12.5%) and a pre-gelatinized starch (1.75%) and the addition of 2 tsps of water. The filling can be used to bake a cobbler when the cobbler batter is poured on top and microwaved for 1 min. This technique can also be used to create gravies, sauces, soups to be used in combination with the microwaved batter.

The skilled practitioner recognizes that whole oat groats are whole hulled oat grains that have been processed before flaking. Oat groats are the kernel product resulting from the cleaning and drying of oats, which removes the hulls. The processed oats useful in the present invention are prepared from whole oat groats. The whole oat groats are steamed to deactivate enzymes and then processed in a kiln, or dryer, to develop flavor and to at least partially cook starch in the groat. The groat then is steamed again to condition the groat in preparation for flaking. The flakes then are dried to the desired moisture content. The conditions under which these processes typically are carried out are known to a skilled practitioner.

After steaming, the groats are subjected to high temperature treatment in, for example, a kiln or a dryer, until the whole oat groats have reached a temperature of from about 225° to about 315° F., preferably from about 275° F. to about 285° F., and a moisture content of from about 2 to about 8 percent. This treatment is used to develop flavor and can occur in any commercially available hot air oven or dryer or other suitable available apparatus. This drying step, also called toasting, typically requires a period of about 4 minutes to about 120 minutes, preferably from about 15 to about 25 minutes. During this treatment, the whole oat groats are continually agitated in order to prevent overheating of any particular portion of the oat groats. After the heating treatment is completed, the oat groats must be cooled rapidly to below 150° F. in order to stop the toasting operation and prevent overtoasting.

The cooled, toasted oat groats then may be pearled to remove the outer layer (sometimes called the pericarp) of the oat groats. The pearling of the oat groats can be performed by any well-known and commercially available abrasive roll.

The pearled groats then are steamed prior to being flaked. The steaming process is a means of reducing the amount of fines and breakages in the flaked product. The oats are heated utilizing steam at a temperature of from about 190° to about 210° F., preferably about 205° F. for a period of from about 2 minutes to about 5 minutes, preferably about 3 minutes. The oats then have a moisture content of from about 13 to about 16 percent, preferably about 15 percent.

The hot, steamed oats then are fed to the conventional flaking rolls and equipment. With the guidance provided herein, the skilled practitioner will be able to prepare whole oat groats in an appropriate manner.

Thus-prepared hulled oat grains then are flaked by any known method. The prepared groats may be steel-cut, rolled, or flaked in any manner known to the skilled practitioner that will yield the desired thickness. The groats are not cut, and therefore yield whole oat flakes that have the advantage of being a healthful, whole-grain product.

The skilled practitioner recognizes that typical commercial flaking processes will result in some small percentage, perhaps about 5 to about 10 percent, of flakes that are thinner and some that are thicker than the endpoints of the range. So long as the percentage of flakes outside the range remains a small percentage of the total, any potential adverse effect will be minimized.

Because whole oat groats are flaked, the dimensions of the oat flakes typically vary as the sizes of oat groats varies at the point at which the flake is formed. For the purposes of this invention, the thickness is maintained within the ranges disclosed herein and the remaining dimensions are not strictly controlled.

The resultant product is a tasty whole grain product appreciated by consumers for both its organoleptic properties and characteristics and its quick and easy method for preparation. The product also is healthy and nutritious, as it is a whole grain product.

### EXAMPLES

### Example 1

Apple Cinnamon Microwaveable Muffin

Oats—30 g

Baking Mix—27 g

Apple Pieces—10 g

Apple Flavor—1 g

Caramel Color—0.12 g

Water—63 g

Baking Mix Ingredients

Cake Flour

Brown Sugar

Bakery Blend (whey, propylene glycol monoesters, mono triglycerides, sodium

caseinate, sodium stearoyl lactylate, di sodium phosphate)* (3-5%)

Dried Whole Egg

Oil

Instant Clear gel (modified corn starch)*

Mono Calcium Phosphate

Dextrose

Baking Soda

Dried Egg White

Salt

Stabilizer Blend (carrageenan, guar, lecithin)*

The dry ingredients are combined in a container and mixed. Water is added and the batter is stirred until nice and homogenous. The batter is added to muffin mold and then microwaved in a 1000 watt microwave for 1:15 minutes. The muffins are cooled for 1 minute and then discharged from mold.

### Example 2

Apple Cinnamon Microwaveable Muffin

Whole Grain Oats—41.1 g

Brown Sugar—21.0 g

Apples—12.5 g

Sugar—3.48 g

Wheat flour—3.47 g

Whole eggs—3.45 g

Flavor—2.92 g

Honey—1.73 g

Other ingredients: Soybean Oil, Enriched Bleach Flour, Whey, Propolyene Glycol Monesters, Mono, Di glycerides, Vegetable Shortening, Maltodextrin, Monocalcium Phosphate, Egg White, Salt, Dextrose, Sodium Bicarbonate, Sodium Caseinate,carrageeenan, Guar Gum, Soy Lecithin, SSL, Cinnamon, sodium stearate, disodium phosphate, ascorbic acid, citric acid, niacinamide, Pyrodoxinne, hydrochloride, riboflavin, thiamin mononitrate, folic acid.

The ingredients are mixed together. The batter is added to muffin mold and then microwaved. The muffins are cooled and then discharged from mold.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A microwavable whole grain batter comprising whole grains, at least one leavening agent, at least one texturizing agent, and water; wherein the whole grains comprise at least 10 wt % of the total batter weight.

2. The microwavable whole grain batter of claim 1 wherein the whole grain is selected from the group consisting of oats, wheat, corn, barley, and mixtures thereof.

3. The microwavable whole grain batter of claim 1 wherein the whole oats comprises 30 wt % to 50 wt % based on total weight of the batter.

4. The microwavable whole grain batter of claim 1 wherein the whole grain is oats.

5. The microwavable whole grain batter of claim 4 wherein the oats are a combination of quick oat flakes having a flake thickness of about 0.016 inches to about 0.020 inches, flaked from a cut groat ⅓-⅙ its original size, and a baby instant oats having a flake thickness of about 0.013 inches to 0.020 inches, and piece size of the oat flake 1/9- 1/36 the original size of the native oats kernel.

6. The microwavable whole grain batter of claim 1 wherein the leavening agent is selected from the group consisting of baking powder, baking soda, monocalcium phosphate, potassium bitatrate, and mixtures thereof.

7. The microwavable whole grain batter of claim 1 wherein the texturizing agent is at least one selected from the group consisting of starches, modified starches, gum acacias, alginates, carrageenans, carboxymethylcellulose, gelatin, guar gum, locust bean gum, pectin, and xanthan gum.

8. The microwavable whole grain batter of claim 1 further comprising a food quality acid.

9. The microwavable whole grain batter of claim 1 wherein the batter further comprises flour, sugar, proteins, fruit pieces, nuts, chips, flavors, and combinations thereof.

10. A baked product prepared in the microwave with the microwavable whole grain batter of claim 1.

11. The baked product of claim 10 wherein the product comprises muffins, cookies, cake, or bread.

12. The baked product of claim 10 wherein the baked product further comprises a topping, wherein the topping is applied pre-microwaving.

13. The baked product of claim 12 wherein the topping includes oat flakes, granola, breadcrumbs, crisps, sugar, butter, shortening, spices, flavors, and combinations thereof.

14. The bakery product of claim 10 wherein the product contains 20 to 30 g whole grains per 56 g serving.

15. A method of making a microwavable whole grain batter comprising mixing at least 10 wt % whole grains, at least one leavening agent, and at least one texturizing agent to form a dry mixture; then adding water to the dry mixture in an amount sufficient to form a batter.

16. The method of claim 15 further comprising preparing the whole grains by removing the hulls, thermally processing to deactivate enzymes, and cooking.

17. A method of forming a baked product comprising microwaving the batter of claim 1.
